(19) United States
(12) Patent Application Publication
(10) Pub. No.: US 2008/0162831 A1
(43) Pub. Date: Jul. 3, 2008

(54) Management/circuit arrangement and memory management system

(75) Inventors: Ralf Herz, Freiburg (DE); Alf Rieckmann, Freiburg (DE); Volker Wagner, Freiburg (DE); Jonah Proujanscy-Bell, Lexington, MA (US)

Correspondence Address: Maginot, Moore & Beck;Chase Tower, Suite 3250, 111 Monument Circle, Indianapolis, IN, 46204, US

(73) Assignee: MICRONAS GmbH, Freiburg (DE)

(21) Appl. No.: 11/897,969

(22) Filed: Aug. 31, 2007

(30) Foreign Application Priority Data
Sep. 1, 2006 (DE) 102006041306.7-53

(51) Int. Cl. G06F 12/00

(52) U.S. Cl. 711/154; 711/E12.001

(57) ABSTRACT

The invention relates to a memory management/circuit arrangement provided with a memory device (MR), which can be controlled so that data (d) that has been input first is output first, and with a memory control device (C) which is associated with the memory device (MR), used to control the input of the data (d) from a device (D1) which provides the data (d) into the memory device (MR), and to control the output of the data from the memory device to one data receiving device (D2), wherein the memory control device and the memory device (MR) are arranged in the circuit arrangement as physically separate components, and the memory control device (C) is linked in order to control the input of the data (d) and in order to control the output of the data to one or more data providing devices and data receiving devices (D1, D2).

The invention relates to a memory management/circuit arrangement having the characteristics according to the preamble of patent claim 1, and to a memory management system having the characteristics according to the preamble of patent claim 8.

In order to communicate in systems which have multiple independent processing units, efficient methods are required for transmission of data. Even within a single unit which is equipped with a single circuit arrangement on a circuit board and with several data processing units, memory units, etc., deployed on the circuit, a structured communication should be established between the logical routines, for example of a processor. Intermediate storage of data must be therefore usually provided within the framework of a data transmission, wherein common access memory devices are used for different processing units. The data can be thus transmitted with such an arrangement in a simple manner in any direction. However, the synchronization between related processes, for example, in order to provide notification about transmitted data, can be very complicated.

If the data is transmitted by one sender, representing a first device, and only in one direction to a receiver, which represents a second device, memory devices are often used which can be controlled so that the data which was input first is output first. Such memory devices are usually referred to as FIFO (first-in-first-out) device. The transmitting device is in the case provided with a write connection, which is used in order to write in a memory area of the memory device. The receiving device is provided with a read connection, which is then used to read the data which has been written to the memory device according to the same sequence.

In order to communicate between processing devices in embedded systems, such FIFO memory devices are used with an integrated memory area for a fixed number of FIFO elements with a uniform size. This memory area can consist of several registers, or with larger data amounts, it can consist of one or several RAM blocks (RAM: Random Access Memory/Direct Access Memory). The data in such a case written directly into the FIFO memory device in which the data is stored and then read by the receiver, which is known from U.S. Pat. No. 4,151,609.

During the use of a RAM memory, it is not technically possible to shift data from one cell to another. Therefore, such a storage device is treated as a ring memory, in which the address for writing or reading migrates. When the end of the memory device is reached, the operation jumps again to the beginning, which is known from U.S. Pat. No. 4,803,654.

A major disadvantage of FIFO memory devices which have an integrated memory area is that fact that the size of the memory area in the FIFO storage device must be predefined during the design phase. A subsequent modification of the size of the memory area or reallocation of the memory areas between the FIFOs and other data or different FIFOs is not possible.

A FIFO memory device can be also based exclusively on a software model. This is, however, associated with considerable expense, as access to various processing units or processing devices must be coordinated. Without supporting hardware, computing time extensive control routines are required to ensure consistent FIFO memory device operations.

The task of the invention is to provide a memory management/circuit arrangement having an improved FIFO memory device, in particular one that makes it possible to manage a subsequent adjustment according to a concrete memory area requirement. In addition, a memory management system is proposed which supports such a circuit arrangement.

This task is achieved with the memory management/circuit arrangement having the characteristics according to patent claim 1, and with the memory management system which has the characteristics of patent claim 8. Advantageous embodiments are the subject of dependent claims.

Preferred is a memory management/circuit arrangement, provided with a storage device enabling control so that data that has been input first is output first, and with a storage control device associated with the memory device, which is used to control the input of the data from a device supplying data into the memory device and to control the output of the data from the memory device to a data receiving device, wherein the memory control device and the memory device are arranged in the circuit arrangement as physically separated components, and wherein the memory control device which controls the input of the data and which controls the output of the data is connected with the data supplying and data receiving device or devices.

Accordingly, preferred is a memory management system for management of a memory device, which can be controlled so that data that is input first is output first by means of a memory device associated with a memory control device, wherein one input of the data from a unit supplying data into the memory device is controlled, and one output of the data from the memory device to one of the device receiving units is controlled, and wherein by means of the memory control device, which is used as a component in the circuit arrangement that is physically separated from the memory device(s), the data providing and/or receiving device is controlled in order to control the input of data into the memory device, or to control the output of data from the memory device.

The concept of the device and the concept of the system are thus based on physical separation of the functionality of a known FIFO memory device having an integrated control component, which on the one hand has a FIFO memory device, and on the other hand an actual FIFO memory control device which is a separate device. In interaction with the memory control device can be also used units, in particular structurally independent devices, or, for example, a software process or a DMA unit (DMA: Direct Memory Access), which manage the FIFO memory device and the access to data in such a memory device, or the storage of data in such a memory device.

The memory control device and the memory device are preferably arranged in the circuit arrangement as physically separate components. This enables an implementation which is independent of one memory module or one memory control device integrated in the memory module.

The memory control device and the memory device are not necessarily connected with each other to control the input of the data and to control the output of data. The memory device is therefore not controlled directly from the memory control device. The first and the second unit access an address that is provided by the memory control device directly in the memory device. To provide access for the data providing unit and/or the data receiving device on the memory device, the memory control device transmits a corresponding memory address to the data providing unit and/or to the data receiving unit. The data providing unit and/the data receiving unit access the memory device at the memory address of the memory device.

The memory control device is connected to the data providing unit and/or to the data receiving device through a bus for transmission of a memory address in order to provide access to the data providing unit and/or the data receiving unit. [b1]

The memory device is preferably provided with a write connection for input of data from the data providing unit, which is implemented as a first unit, and with a read connection for output of data to the data receiving unit, which is implemented as a second unit.

The memory control device is preferably provided with a memory unit for storing an address in an associated memory area of the memory device in a primary (overriding) memory device.

The memory control device is preferably provided with a memory unit for storage of a size of the associated memory area of the memory device.

For the management of the access to the memory, the data providing unit and the data receiving unit communicate through a separate communication link, preferably directly with the memory control device.

The memory device is preferably dimensioned to enable selective, scalable occupancy in large areas of a memory within a primary memory device. The memory device can be advantageously provided for temporary use in a primary memory device.

The implementation of the FIFO memory control device in the form of a structurally independent component, which is separated from the actual structure of the memory device for storage of data, makes it possible to provide an efficient hardware/circuit arrangement which has several advantages.

In comparison, for example, to a software-based solution, a memory device operation which is structurally independent of a processor operates significantly more efficiently in a processor. Each access, which would require many cycles in order to load FIFO conditions in the memory device with a software-based solution, the execution of calculations and new storage of changed conditions is handled by the proposed memory control device with a single memory access operation performed by the data providing or writing device, or by the data reading device.

In addition to efficiency, such an automated design of access at any time also ensures consistent FIFO conditions.

Particularly in systems which are provided with several processing devices, no additional expenditure is required for the synchronization of the access to the memory control device constructed as a FIFO control device. Unlike with software-based extensions, which can lead to a significant performance loss when synchronization measures are implemented, the present solution provides another remarkable advantage.

In comparison to a conventional hardware FIFO implementation, the FIFO memory control device is significantly more flexible because the memory available in the system can be allocated at any point in time in an optimal manner to different FIFO memory devices and processing units or processing devices.

The entire linear memory, and also only one part of a single memory device, can be used in an advantageous manner as a data storage device of a FIFO memory device, in particular of a RAM (Random Access Memory), which has only one read/write connection in the form of a single port.

An advantageous use can be therefore achieved with devices which are provided with a certain hierarchy of storage, i.e. in arrangements which have memory regions, which are provided with different sizes in the system depending on the circumstances and which can be addressed with different speeds, which can in some cases also depend on the locality. With similar devices that are equipped with a memory hierarchy, the FIFO memory control device can manage FIFO data without conflicts in all memory areas of different localities using a differing access speed depending on the requesting device or unit.

An embodiment of the invention and variants thereof will now be explained in more detail based on the attached figures. The figures show the following:

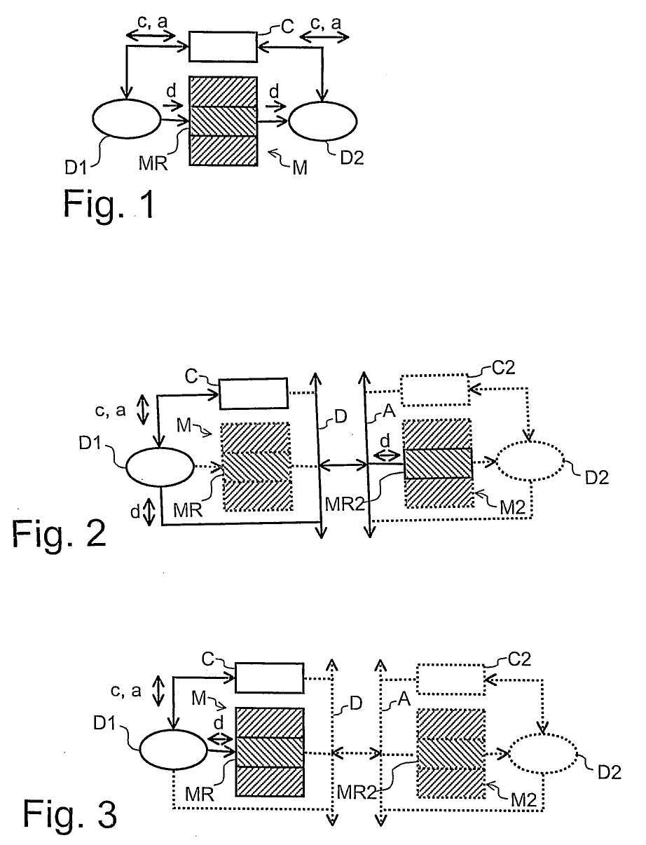

FIG. 1 a basic principle of the partitioning in a FIFO memory control device and of a FIFO memory device connected with two external units,

FIG. 2-6 different variants thereof,

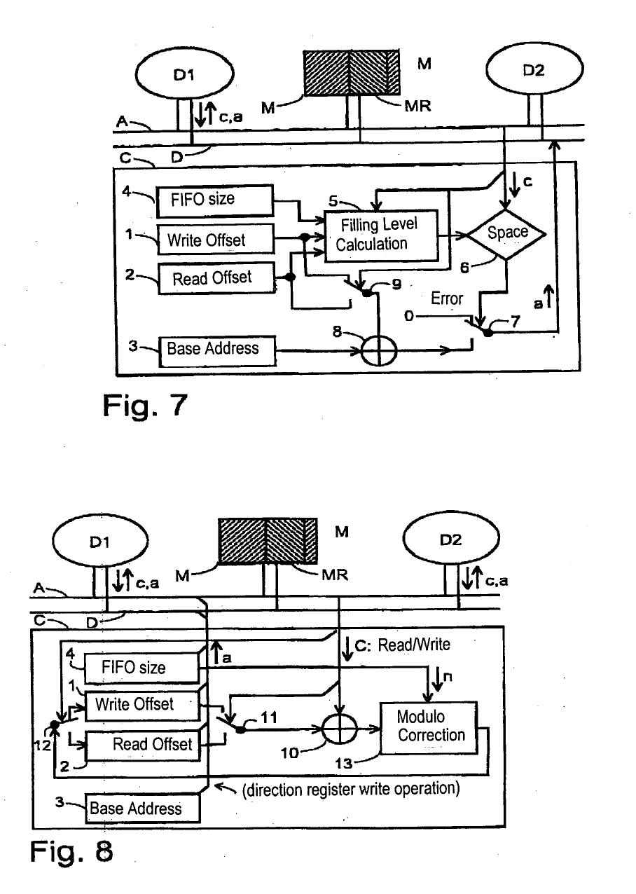

FIG. 7 a schematic representation of a configuration and method used for a read access in such a memory control device, and

FIG. 8 a schematic representation of a configuration and a method used for a read access in another such memory control device.

FIG. [b2] 1 shows a schematic representation of the basic concept of a preferred memory management/circuit arrangement, which is provided with a memory device MR, used as a memory region in a primary memory M. As an alternative, the memory device MR could be in principle also replaced by an independent memory module. However, it is advantageous when embodiment forms are used in which the memory device MR is constructed in a primary memory in a memory area which can be defined also subsequently with respect to its dimensions. The memory device MR is constructed for example as a controllable FIFO memory device in which data d that has been input first is also output first.

A memory control device C is used in order to control access to the memory device MR, so that the data d that has been input first is also output first.

However, the memory control device C is constructed as a standalone unit and it is physically separated from the memory area MR. Instead of a conventional FIFO memory, the FIFO functionality is separated on the one hand in the FIFO memory control device C, and on the other hand in the memory device MR which is used as a data storage or data memory device.

The data d is input from independent units D1, D2 for storage, or called up during read operations. These units can be, for example, units which are based on a software process, or DMA units. The units D1, D2 can be in principle also arranged as structurally separate components, which are deployed on a common circuit board provided with a memory control device C and the memory device MR, or the memory M. However, the units D1, D2 can be also provided as independent components which communicate with the remaining components through a communication link.

In the embodiment which is illustrated in FIG. 1, the first of the units is designed as a first unit D1 that provides data d, and inputs the data through at least one write connection to the memory device MR. The second of the devices is designed as a second device D2 that is equipped with at least one read connection and which reads data d from the memory device MR. For the management of the memory access operations, the first and the second units D1, D2 communicate via separate communication links, in particular via an address bus, directly with the memory control device C. Control instructions, and when required, addresses, are signaled through these communication links. In particular, the control device C transmits to both respective units D1, D2 the appropriate address a for one access to the memory device MR.

Moreover, additional information, which can for example comprise a number of data items to be written or read in the form of control instructions c, is transmitted through this communication link. Accordingly, the first and the second unit D1, D2 themselves access directly the memory device MR within the memory region which was communicated with the address a.

Modified arrangements are illustrated in FIG. 2-6. Only significant differences relative to FIG. 1 will be described hereinafter. The same components and functions are indicated with the same reference symbols also in the remaining figures, unless further components or other aspects relating to these components are described. Components which are less important for the understanding of each embodiment, or components which are not relevant, are only sketched with a dotted line to create a clearly organized illustration. Such components may be in some cases also completely eliminated in modified embodiments.

FIGS. 2 and 3 illustrate an embodiment in which a memory hierarchy is used. This makes it possible to create, if necessary, different sizes of the memory area used in the memory devices in the system, which can be addressed with different speeds. This enables a so called locality function. The FIFO memory control device C can manage without conflicts the FIFO data, comprising data d, in all memory devices M or in all memory devices MR, MR2 in different localities. At the same time, access is enabled with different speeds relative to each requesting first and/or second unit D1, D2.

Any desired memory area can thus be used with selective access with the memory devices MR, MR2 for data d, which is written and read as FIFO data. For embedded systems can be used for example jointly accessible SRAM blocks (SRAM: Static RAM), or a jointly used external DRAM (DRAM: Dynamic RAM) can be employed. However, in principle it is also possible to use the memory in another system, for example with a fixed disk or even with a memory distributed in a network memory region with one or more memory devices for the storage of FIFO data.

Accordingly, FIG. 2 shows a first memory device M in a first system area, and a second memory device M2 in a second system area. Both memory devices are connected, respectively, with a jointly used data bus D and with a jointly used address bus A. Each of the system areas is preferably provided with its own memory control device C, C2. The first unit D1 obtains access via a communication link provided for interchange of addresses a and other control instructions c on the first control device C in its own system section. In addition, the first unit D1 is provided with a link through the buses D, A in order to transmit data d as FIFO data to the second memory device MR2 in a second system section. The storage control device C in the first system section thus manages as a local FIFO memory control device a hierarchically arranged memory having a second memory device MR2.

FIG. 3 shows an embodiment which substantially corresponds to the embodiment according to FIG. 1. A local FIFO control unit in the form of a memory control device C, which provides data d from the viewpoint of the first unit D1, is used to manage the memory device MR in the same system section that contains the first unit D1. A local memory device M or a local memory device MR associated therewith is thus managed with a local memory control device C.

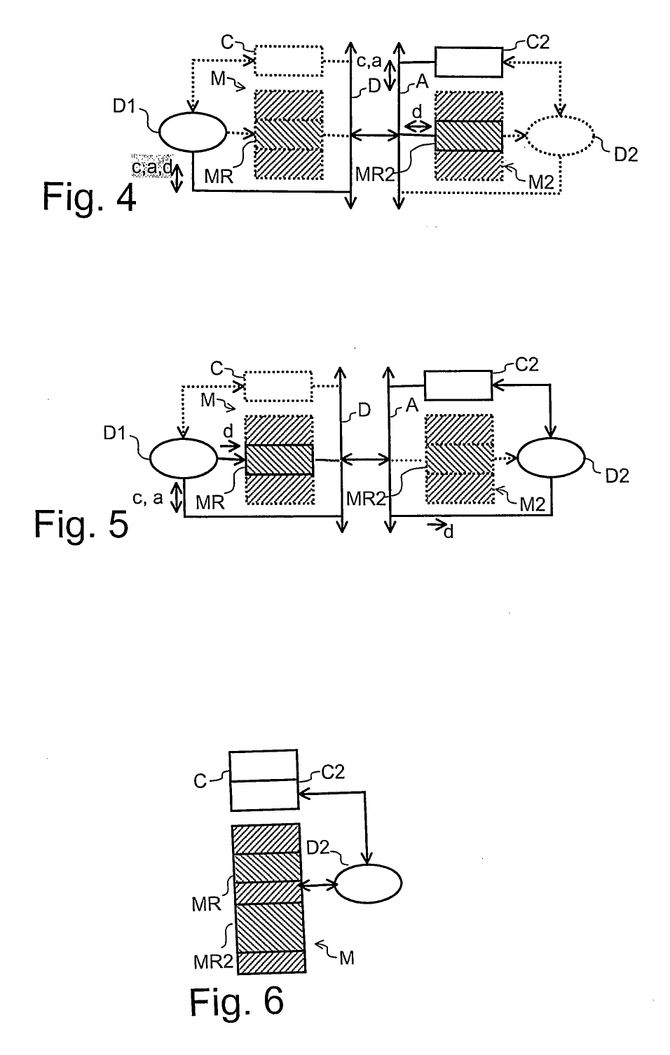

FIG. 4 shows an embodiment indicated from the viewpoint of the first data processing unit, in particular data providing unit D1, wherein both the memory control device C2 and the memory device MR2 in the second system section are used for FIFO data storage of data d. In this case, this first unit D1 can have selective access, depending on the configuration of the system, to either this memory control device C2 that is used as a second control device, or to the first memory control device in its own system section, or the first unit D1 can have access only on this second memory control device C2 in another system section, if for example no suitable memory device C is present in its own system area.

FIG. 5 shows a modification of the embodiment, in which the first unit D1 uses FIFO storage of its data d, for which the first memory area MR in the first memory device M of its own system area is used. However, for the management of this first memory area MR, the first unit D1 accesses a memory control device in the form of the second memory control device C2 in another system area. The transmission of addresses a and of other control instructions c is thus realized from the buses D, A through the communication link, preferably with an interposed bus system.

While various modifications are sketched in the drawings based on the FIG. 2-5, in which the individual components can be distributed throughout various system areas, or when required, even in systems which are separated from each other, FIG. 6 shows yet another modified embodiment, in which several memory control devices C, C2 and several memory devices MR, MR2 are arranged in one system region for FIFO data storage. Naturally, a combination of various embodiments is also possible, so that for example several such memory devices MR, MR2 and/or several memory control devices can be provided in various system areas or systems.

As one can clearly see from FIG. 6, the FIFO architecture is preferably scalable. Multiple FIFO memory devices are formed in one memory M with several memory control devices C, C2. The number of these multiple memory control devices C, C2 is preferably defined already within the framework of the circuit design. However, such an architecture is thus fully independent of the number and of the size of the physical data memory device M which is used for the FIFO data.

The size of the FIFO data is determined as a dimension for each individual memory device MR, MR2, or for each corresponding dataset in the associated FIFO memory control device namely the memory control devices C, C2. In particular, the dimension is thus not necessarily static, and it also not necessarily limited to the size of the data elements of the physical memory M.

In the case of an access to such a memory control device C, C2 through a hierarchical bus system provided with corresponding buses, D, A, the position of the corresponding memory device MR or MR2 can be selected at will. The position in the hierarchy determines in each case the access speed of the writing and reading unit D1, D2 on the memory control device C, C2.

The memory control device C, C2 of the various illustrated embodiments manages addresses a for writing in the associated memory device MR or MR2, and for reading from these memory device MR or MR2, and hands over these addresses a to the corresponding first or second unit D1, D2. The data d itself is written by the first unit D1, or optionally also by the second unit D2, directly into the memory device MR, MR2, which is addressed in this manner, or the data is read from the addressed memory device MR, MR2.

In order to perform these operations, the requesting unit D1, D2 requests from the relevant memory control device C the address a for FIFO storage, to which the data d must be written or from which the data D must be read. When the unit D1, D2 which requests the address does not receive a valid address in response, the unit will not access the corresponding memory device MR, MR2. The memory control device C, C2 can thus prevent access to the associated memory device MR, MR2, for example when the memory region of the memory device MR, MR2 which is associated with FIFO storage is full, or if no data was available in the memory device MR, MR2 during a read request. A consistent access is ensured in this manner for the sending or receiving units D1, D2.

After the writing or reading of data d, the reading or writing unit D1, D2 informs the relevant memory control device C, C2 which is in charge of FIFO storage about the completion of the access to the memory device MR, MR2. From this moment on, the reading of the data d can be allowed through the second unit D2 which is used as a receiver, or the overwriting of old data by the first unit D1, which is used as a sender, can be allowed by the memory control device C, C2.

FIG. 7 illustrates in a simplified form an example of the configuration and functions of the memory control device C. The figure shows the registers and operations used during the access to reading operations in a memory device MR, for example by the second unit D2. The registers and the operations are in this case used in order to calculate the next read or write address connected with the FIFO storage.

The memory control device C comprises a storage unit 1 for the actual write address, and a storage unit 2 for the actual read address. In this case, the addresses which are stored in the memory devices 1, 2 can be registered as two full addresses. In addition, or alternatively, a base address can be realized in memory unit 3 for the base address, and both first memory units 1, 2 can be used for the realization of the storage of a write or read offset.

The memory control device C is further also equipped with a fourth memory unit 4 for storing the size n of the memory area of the memory device MR. This size is used in order to reset the addresses a to the beginning when the FIFO end is reached.

In addition, the size n is used to determine the number of used and free FIFO cells in the memory device MR.

In order to calculate the filling level, the memory control device C is provided with a logic which is equipped with a filling level calculation device. This filling level calculation device obtains the values of the write offset and the read offset, and of the size n, all of which are input to the device. In addition, the filling level calculation device inputs a corresponding control instruction from the requesting device D1, D2. The access instruction, which preferably includes with the request of a write operation also the number of the required storage cells, is input also into a space condition unit 6, contained in the logic, which compares the requested storage requirement to the available storage space calculated by the filling level calculation device 5. If sufficient storage space is available, the address a is output by means of a switching device 7 for the corresponding writing operation on the address bus A or on corresponding address lines, and the first unit D1 is notified. As a result, the first unit D1 can access directly memory device MR address with this address a and store its data d therein. If the space in the memory device MR is not sufficient, an error signal and/or an invalid signal will be output, for example with the address “0”, so that the first unit D1 will not carry out the requested writing operation.

In the embodiment shown in the illustration, the switching device 7 inputs as an address a an address that is formed with the addition of the base address either to a write offset or to a read offset. The addition can be performed for example by an adder 8, which is connected between the memory unit 3, used for the base address, and another switching device 9.

In this case, the other switching device 9 can input selectively the write offset or the read offset of the first or the second memory device 1, 2. This other switching device 9 is preferably switched on with the control instruction c, which is also input to the filling level calculation unit. It is advantageous when the control instruction c thus includes both information about a requested write and read operation, as well as information about the request for memory storage in the memory device MR.

FIG. 8 shows in a simplified form the used registers and operations of such a memory device C, illustrating a requested write access in order to update the FIFO status or during a direct writing operation to a register. FIG. 8 shows in a simplified form the registers and operations of such a memory device C that are used to update the FIFO status during a requested write access, or the status during a direct writing operation to a register.] During this operation, the four memory units 1-4 are used again for the write offset, the read offset, the base address and the FIFO size. A write or read operation is requested again by means of a control instruction from the first unit D1 or from the second unit D2. The control instruction is in this case input both to another adder 10, and to third and fourth switching devices 11, 12. With the third and fourth switching devices 11, 12, access is switched either to the write offset or the read offset in the first or second memory device 1, 2. The value of the requested storage space is then added up by the adder 10 either to the write offset or to the read offset. The result of the addition is input to a modulo correction unit 13, which also inputs the size n from the memory unit 4 for the FIFO size. Accordingly, the result of the module correction unit 13 is stored again via the fourth switching device 12 in the first or the second memory unit 1 or 2, either for the write offset or for the read offset.

In addition, lines and/or a bus can be also provided, which are connected to the four memory units 1-4 in order to enable direct register/write operations.

The various units shown in the FIGS. 7 and 8 can be also replaced by structural components of a processor which carry out procedural development steps, including a software program in a processor. In particular, such a memory control device C is preferably equipped with all the components and capabilities required to realize the operations according to both FIG. 7 and FIG. 8.

The communication of the writing and reading processing units, having for example the form of the first and/or second unit D1, D2, provided with the memory control unit C which serves as a FIFO control unit, can be carried out in the case of a programmable unit very efficiently with the development of the management and control access in the memory address space. In this case, it can be signaled through the address lines or through an address bus A whether the values should be written in the memory device MR, or whether they should be read from the memory device MR. In addition, also the number of the values to be written or to be read via these address lines or via this address bus A can be preferably signaled with corresponding control instructions c.

In order to obtain an address a to which the next FIFO values can be written, or at which the next FIFO values can be read, it is advantageous when only a single operation is required with a similar arrangement and method. Accordingly, only one single write operation is required also to signal that writing or reading has been completed.

In the example described above, the type of the access during an access to the memory device C for FIFO storage, that is to say during reading or writing, is unrelated to the selection as to whether data d should be written to the memory device MR, or whether data should be read from this memory. This is preferably realized with a selection bit in the address a.

It is also advantageous when a direct link is can be established between the signal of the control block of the memory control device and a hardware block.

According to a preferred embodiment, in accordance with the method of the development, for example the first unit D1 exercises control in order to reserve a number of FIFO cells of the memory device MR for writing operations. This access through the first unit D1 preferably occurs through the input of a corresponding control instruction c via a direct communication link to the memory control device C.

When FIFO storage is requested, the memory control device C tests whether at least as many memory cells are still free in the memory device MR as the number that was requested by the first unit D1, and when required, the device returns the address a of the first FIFO cell in the memory area of the memory device MR. If fewer cells are available than the number of required cells, this fact is preferably signaled with a special offset value replacing a memory address.

It is preferred when it is signaled through the address lines or through the address bus A from the first unit D1 to the memory control device C that the value or the data d is to be written, wherein the number of the data items d to be written is preferably also signaled.

The writing of the data d is performed at the address a, which is returned by the memory control device C in a separate memory area for the actual data d. After the writing of the data d in the memory device MR, the end of the writing operation of the memory control device C is preferably communicated via a second control-write-access with the another control instruction c. The memory control device C can as a result then also release data d which was written in the memory device for FIFO reading.

The reading unit, for example the second unit D2, queries by means of a control-read-access, for example with the input of a corresponding control instruction c from the memory control device C, whether at least n cells are available in the FIFO memory area of the memory device MR. The memory control device will return in this case the address a of the first cell if the data d is available. Otherwise, the memory control device C will return an error signal or a special offset value.

It is preferred when it is signaled through the address lines or through the address bus A from the second unit D2 to the memory control device C that the values are the data d are to be read, wherein the number of the data d to be read is preferably also signaled.

If the data d is available, the second unit D2 will then read the data d at the returned address from the memory device MR, which is constructed in a separate memory M.

After the reading of the data D, the end of the reading operation of the memory control device is communicated through a second control-read-access from the second unit D2, so that the memory area which became free in the memory device MR can be used for new incoming data.

1. A memory management/circuit arrangement, comprising
a memory device (MR; MR, MR2), exercising control so that data (d) that has been input first is output first, and
a memory control device (C), associated with the memory device (MR; MR, MR2) in order to control the input of data (d) from a unit (D1) making data (d) available in the memory device (MR; MR, MR2), and to control the output of the data (d) from the memory device (MR; MR, MR2) to a data (d) receiving unit (D2),
characterized in that
the memory control device (C) and the memory device (MR; MR, MR2) are arranged in the circuit arrangement as physically separated components, and
the memory control device (C) is connected with one or more units (D1, D2), which provide data (d) and which receive data (d) in order to control the input of the data (d), and in order to control the output of the data (d).

2. The memory management/circuit control arrangement according to claim 1, wherein the memory control device (C) and the memory device (MR; MR, MR2) are arranged in the circuit arrangement as physically and structurally separate components [b3].

3. The memory management/circuit control arrangement according to claim 1, wherein the memory control device (C) and the memory device (MR; MR, MR2) are not connected to each other in order to control the input of the data (d) and in order to control the output of the data (d).

4. The memory management/circuit control arrangement according to claim 1, wherein the memory control device (C) is connected with the unit (D1), which provides data (d) and/or the unit (D2), which receives data (d), is connected via a bus for transmission of a memory address (a) for access to the unit (D1), which provides data (d), and/or with unit (D2), which receives data (d) at the memory device (MR; MR, MR2).

5. The memory management/circuit control arrangement according to claim 1, wherein the unit (D1), which provides the data (d), and the unit (D2) which receives the data (d), signals the number of the data items to be written or to be read and/or the direction of the data transfer to the memory control device (C) with one part of the address on the address bus.

6. The memory management/circuit control arrangement according to claim 1, wherein the memory device (MR; MR, MR2) is equipped with a write connection for the input of data (d) from the unit (D1) which provides data (d) as a first unit, and with a read connection for the output of the data (d) to the device (D2) which receives data (d) as a second unit.

7. The memory management/circuit control arrangement according to claim 1, wherein the memory control device (C) is equipped with a memory unit (1; 3) for the storage of an address of the associated memory area of the memory device (MR) in a primary memory device (M).

8. The memory management/circuit control arrangement according to claim 1, wherein the memory control device (C) is equipped with a memory unit (4) for the storage of the size of the associated memory area of the memory device (MR).

9. A memory management system for managing a memory device (MR; MR, MR2), enabling control so that data (d) that has been input first is output first by means of a memory control device (C) associated with a memory device (MR; MR, MR2), wherein one input of the data (d) from one of the units (D1) which provides data (d) into the memory device (MR, MR, MR2) is controlled, and one output of the data (d) from the memory device (MR, MR, MR2) to one of the device units (D2) which receives the data (d) is controlled, characterized in that
control is exercised by means of the memory control device (C), which is used as a component that is physically separated from the memory device (MR; MR, MR2) in the circuit arrangement, so that data (d) is provided directly by the data providing and/or data receiving unit (D1, D2) in order to control the input of the data (d) into the memory device (MR; MR, MR2), or in order to control the output of the data (d) from the memory device (MR; MR, MR2).

10. Memory management control system according to claim 9, wherein the memory device (MR; MR, MR2) is not controlled directly by the memory control device (C).

11. Memory management control system according to claim 9, wherein for one access to the device (D1) which provides data (d) and/or to the device (D2) which receives data (d), the memory control device (C) on the memory device (MR; MR, MR2) inputs a memory address (a) to the unit (D1) which provides the data (d) and/or to the unit (D2) which receives the data (d).

12. Memory management control system according to claim 11, wherein the device (D1) which provides the data (d) and/or the device (D2) which receives the data (d) accesses the memory device (MR; MR, MR2) at the memory address (a) of the memory device (MR; MR, MR2).

13. The memory management control system according to claim 9, wherein for the management of the memory access, the device (D1) which provides the data (d) and/or the device (D2) which receives the data (d) communicate through separate communication links directly with the memory control device (C).

14. The memory management control system according to claim 9, wherein the memory device is dimensioned in a scalable manner for a selective engagement of the size of a memory area within a primary memory device (M) making available the memory device (MR).

15. The memory management control system according to claim 9, wherein the memory device (MR) is temporarily provided in a primary memory device (M).

16. The memory management control system according to claim 9, for the control of a memory management/circuit arrangement according to claim 1.

17. The memory management control system according to claim 9, characterized in that the memory control device (C) controls the transmission of the data in such a way that data (d) that has been input first will be also output first.
